(19) United States
(12) Patent Application Publication
(10) Pub. No.: US 2020/0220165 A1
(43) Pub. Date: Jul. 9, 2020

(54) NEGATIVE ELECTRODES FOR USE IN ACCUMULATORS OPERATING ACCORDING TO THE ION INSERTION AND DEINSERTION OR ALLOY FORMATION PRINCIPLE AND WITH SPIRAL CONFIGURATION

(71) Applicant: COMMISSARIAT À L'ÉNERGIE ATOMIQUE ET AUX ÉNERGIES ALTERNATIVES, Paris (FR)

(72) Inventors: Elise Gutel, Grenoble (FR); Lionel Blanc, Grenoble (FR); Willy Porcher, Grenoble (FR); Yvan Reynier, Grenoble (FR)

(21) Appl. No.: 16/734,638

(22) Filed: Jan. 6, 2020

(30) Foreign Application Priority Data
Jan. 8, 2019 (FR) 1900168

(51) Int. Cl. H01M 4/36; H01M 4/38; H01M 4/587; H01M 4/62; H01M 4/66; H01M 4/04; H01M 10/0587; H01M 10/0525

(52) U.S. Cl. CPC H01M 4/366; H01M 4/386; H01M 4/587; H01M 4/62; H01M 4/661; H01M 2004/027; H01M 4/0492; H01M 10/0587; H01M 4/364; H01M 10/0525; H01M 2220/30; H01M 4/0404

(57) ABSTRACT

A negative electrode for an accumulator functions based on the ion insertion and deinsertion principle and/or based on the alloy formation and dealloying principle. A first layer comprises an active material deposited on a first face of a current collector. A second layer comprises an active material deposited on a second face of a current collector, the first face being opposite the second face. The negative electrode extends lengthwise in an electrode longitudinal direction. Each of the first and second layers is partly coated with an assembly of strips of a metal, the cations of the metal are those involved in the ion insertion and deinsertion process and/or in the alloy formation and dealloying process in the active material of the first and second layers, the strips being separated along the electrode longitudinal direction and each extend lengthwise along a strip longitudinal direction substantially perpendicular to the electrode longitudinal direction.

### CROSS-REFERENCE TO RELATED APPLICATIONS

This application claims priority from French Patent Application No. 19 00168 filed on Jan. 8, 2019. The content of this application is incorporated herein by reference in its entirety.

### TECHNICAL FIELD

This invention relates to a new type of negative electrode intended for use in:
accumulators functioning according to the principle of ion insertion and deinsertion in the active material of the electrode (also called the ion intercalation or deintercalation principle), accumulators of this type possibly being M¹-ion accumulators, where M¹ corresponds to an alkali element (such as Li, Na, K) or M²-ion accumulators, where M² corresponds to an alkali earth element (such as Ca, Mg); or
accumulators functioning according to the alloy formation or dealloying principle with at least one of the active electrode materials;

This new type of electrode being particularly well adapted to be incorporated into accumulators with a spiral configuration.

Accumulators of this type are intended for use as an autonomous energy source, particularly in portable electronic equipment (such as mobile telephones, laptop computers, tooling), in order to progressively replace nickel-cadmium (NiCd) and nickel-metal hydride (NiMH) accumulators. They can also be used to provide the energy supply necessary for new microapplications such as smart cards, sensors or other electromechanical systems and for electromobility.

From the functional point of view, the above-mentioned accumulators function either according to the principle of ion insertion-deinsertion in active materials, or according to the principle of alloy formation and dealloying with at least one of the active materials, such as lithium that can form an alloy with tin.

As an example, considering lithium accumulators, as the accumulator discharges, the negative electrode releases lithium in ion form Li⁺, that migrates through the ion conducting electrolyte and is incorporated in the active material of the positive electrode to form an insertion material or an alloy. The passage of each Li⁺ ion in the internal circuit of the accumulator is exactly compensated by the passage of an electron in the external circuit thus generating an electric current.

On the other hand, reactions that take place within the accumulator when the accumulator is being charged, are inverse to those that take place during discharge, namely:
the negative electrode will incorporate lithium in the lattice of the material from which it is composed, to form an insertion material or an alloy; and
the positive electrode will release lithium, which will be incorporated into the material of the negative electrode to form an insertion material or an alloy.

During the first charge cycle of the accumulator, when the active material of the negative electrode is brought to a lithium insertion potential or the lithium alloy formation potential, some of the lithium will react with the electrolyte on the surface of the grains of active material of the negative electrode to form a passivation layer on its surface. Formation of this passivation layer consumes a non-negligible quantity of lithium ions that is materialised by an irreversible loss of capacity of the accumulator (this loss being qualified as irreversible capacity and that can be evaluated at the order of 5 to 20% of the total initial capacity of the system), due to the fact that lithium ions that have reacted are no longer available for subsequent charge/discharge cycles. Other surface reactions can also take place with consumption of lithium, such as reduction of the oxide layer at the surface of the active material, particularly when it is silicon, to form Li₄SiO₄ type compounds. Furthermore, some of the insertion reactions in the insertion materials can be irreversible, which consumes lithium that will no longer be available afterwards.

Therefore these losses must be minimised during the first charge or at least they should be compensated so that the energy density of the accumulator is as high as possible.

To compensate this phenomenon, a supplementary lithium source in the negative electrode material could be envisaged, which can also act as an ion reserve to compensate for losses during the life of the accumulator and thus to extend it.

To achieve this, techniques for introducing additional lithium into the negative electrode have been disclosed to mitigate the above-mentioned disadvantage, among which mention may be made of “in situ” prelithiation techniques and “ex situ” prelithiation techniques.

Concerning techniques called “in situ”, they consist of introducing metallic lithium (in other words with “0” degree of oxidation) into the negative electrode for example in the form of a metallic lithium powder stabilised by a protective layer (as described in Electrochemistry Communications 13 (2011) 664-667) mixed with ink containing the ingredients of the negative electrode (namely, the active material, the electron conductors and an organic binder), the lithium being inserted spontaneously by a corrosion phenomenon, the advantage of this technique being that it can be directly integrated in the electrode manufacturing process, however with the disadvantages that it cannot enable the use of aqueous pathways for manufacturing the electrodes, due to the use of metallic lithium and that it allows residual porosity to subsist in the electrode once the lithium has been consumed.

Concerning “ex situ” techniques, they consist of electrochemically prelithiating the negative electrode, for example galvanostatically, by placing it in an assembly comprising an electrolytic bath and a counterelectrode comprising lithium, these techniques being used to check the quantity of lithium introduced into the negative electrode, but however also having the disadvantage of requiring that a major experimental set up is implemented. In particular, since the electrode is very reactive to air and to humidity, all assembly steps of the accumulator must be made under a perfectly inert atmosphere.

With regard to prior art, there is a genuine need for negative electrodes for a metallic insertion-deinsertion accumulator with a sufficiently high metallisation ratio throughout the entire volume of the electrodes, so as to mitigate irreversible capacity losses and also, having a sufficiently large surface area so that they can be used, particularly, in accumulators with a spiral architecture.

The authors of this invention have set themselves the objective of satisfying this need by the use of negative electrodes characterised by a specific design.

### PRESENTATION OF THE INVENTION

Thus, the invention relates to a negative electrode for an accumulator functioning based on the ion insertion and deinsertion principle and/or based on the alloy formation and dealloying principle comprising:
a first layer comprising an active material deposited via one of its faces, on a first face of a current collector;
a second layer comprising an active material deposited via one of its faces, on a second face of a current collector, said first face being opposite said second face;

said negative electrode extending in length along an electrode longitudinal direction,

characterised in that each of the first layer and the second layer is partly coated with an assembly of strips each composed of a metal, the corresponding cations of which are those involved in the ion insertion and deinsertion process and/or in the alloy formation and dealloying process in the active material of the first layer and the second layer, said strips being separated from each other along the electrode longitudinal direction and each extending in length along a strip longitudinal direction substantially perpendicular to said electrode longitudinal direction.

In the above and in the following description, negative electrode classically means the electrode that acts as the anode when the generator outputs current (in other words when it is in the discharge process) and that acts as the cathode when the generator is in the charge process.

In the above and in the following description, active material classically means, when the accumulator functions according to the ion insertion and deinsertion principle, the material that is directly involved in reversible ion insertion and deinsertion reactions in electrode active materials during charging and discharging processes, in the sense that it can insert and deinsert ions in its lattice (more specifically, cations in this case corresponding to the metal making up the above-mentioned strips, these ions possibly being alkali ions, particularly lithium ions, when the accumulator is a lithium-ion accumulator, sodium ions when the accumulator is a sodium-ion accumulator, potassium ions when the accumulator is a potassium-ion accumulator, or alkali earth ions such as magnesium ions when the accumulator is a magnesium-ion accumulator, or calcium ions when the accumulator is a calcium-ion accumulator).

In the above and in the following description, active material classically means, when the accumulator functions according to the alloy formation and dealloying principle, a material that is involved in alloy formation or dealloying reactions during charge and discharge processes.

In the above and in the following description, metal means the metallic element at its 0 degree oxidation.

In the above and in the following description, electrode longitudinal direction classically means the direction along which the longest length of the electrode extends, the electrode preferably being in the form of a strip.

In the above and in the following description, longitudinal strip direction classically means the direction along which the longest length of each strip extends, the longitudinal direction of each of the strips being substantially perpendicular, and more specifically perpendicular, to the longitudinal electrode direction.

By disclosing such an electrode design, the authors of this invention have thus provided a solution to problems of irreversible loss of capacity of electrodes, for example large surface area electrodes, particularly with a spiral accumulator architecture, by allowing diffusion of cations originating from the metal making up the strips on the two faces of the electrode, throughout the entire volume of the electrode.

Once the electrodes according to the invention have been brought into contact with an electrolyte (namely, once they have been installed in an accumulator or after being brought into contact with an electrolyte before assembly of the negative electrode in an accumulator), the strips composed of a metal will be subjected to a corrosion phenomenon, from which cations are derived (said cations corresponding to cations involved in the insertion-deinsertion process or alloy formation-dealloying process of the accumulators in which they will be incorporated) that will be able to diffuse within the thickness of the first layer and within the thickness of the second layer.

With such a design, and due to this specific layout of the strips, the negative electrodes according to the invention are also particularly well adapted to be wound around an axis parallel to the electrode width direction so as to enter into the composition of a spiral architecture electrode, this winding taking place more easily than with an electrode of the type in which each strip assembly is replaced by a layer extending along the electrode longitudinal direction. Thicker strips can thus be used than the thickness that could be envisaged if these strips were replaced on the first layer and on the second layer by a layer composed of a metal extending in the electrode longitudinal direction.

The negative electrodes according to the invention are thus in the form of bilayer electrodes (namely comprising a first material comprising an active material and a second layer comprising an active material), the two layers being located on each side of a current collector, these two layers being coated on one of their faces (more specifically, the face opposite that in contact with the current collector) of a strip assembly as defined above, said strips being composed of a metal, the corresponding cations of which are cations involved in the ion insertion or deinsertion process and/or in the alloy formation and dealloying process in the active material of the first layer and the second layer.

The active material in the first layer is conventionally identical to the active material in the second layer.

Furthermore, the active material in the first layer and the active material in the second layer is advantageously not composed of the metal used in the composition of the strips in the strip assembly coating the first layer and the strip assembly coating the second layer.

The active material, either for the first layer and/or the second layer, may in particular be a material that can intercalate or deintercalate ions that are those originating from the metal forming the strips in the strip assembly coating the first layer and the strip assembly coating the second layer and that are responsible for functioning of the accumulator when it functions according to the ion insertion and deinsertion principle.

The active material, either for the first layer or for the second layer, may in particular be a material that can intercalate or deintercalate ions identical to those originating from the metal from which it is composed.

More specifically, the active material, either for the first layer and/or the second layer, may in particular be:
a material that can intercalate or deintercalate alkali ions when the accumulator is an M¹-ion accumulator, in which M¹ represents an alkali ion (such as lithium ions when the accumulator is a lithium-ion accumulator; sodium ions when the accumulator is a sodium-ion accumulator; potassium ions when the accumulator is a potassium-ion accumulator, and the strips in the strip assembly coating the first layer and the strips in the strip assembly coating the second layer are composed of an alkali metal; or
a material that can intercalate or deintercalate alkali earth ions when the accumulator is an M²-ion accumulator, in which M² represents an alkali earth ion (such as magnesium ions when the accumulator is a magnesium-ion accumulator; calcium ions when the accumulator is a calcium-ion accumulator) and when the strips in the strip assembly coating the first layer and the strips in the strip assembly coating the second layer are composed of an alkali earth metal.

In particular, the active material, either for the first layer and/or the second layer, can be chosen from among:
silicon;
a carbon material such as hard carbon, natural graphite or artificial graphite; and
mixtures thereof;

these active materials being adapted for the M¹-ion or M²-ion accumulators mentioned above.

As an example of an active material, mention may be made in particular of a silicon-graphite composite material that is composed, for example of an aggregate of graphite particles and silicon particles.

Furthermore, in addition to an active material, the first layer and the second layer may comprise at least one organic binder and at least one electron conducting material containing carbon.

The organic binder(s) can be chosen from among vinyl polymers such as polyvinylidene fluorides (PVDF), modified celluloses such as carboxymethylcelluloses (CMC) possibly in the form of salts (for example sodium carboxymethylcelluloses, ammonium carboxymethylcelluloses), styrene-butadiene copolymer latexes (SBR), polyacrylates such as lithium polyacrylates, polyamides, polyimides, polyesters and mixtures thereof.

The electron conducting carbon material may be a material comprising carbon in the elementary state and preferably in divided form, such as spherical particles, chips or fibres.

As a carbon material, mention may be made of graphite, mesocarbon balls; carbon fibres; carbon black such as acetylene black, channel black, furnace black, lamp black, anthracene black, charcoal black, gas black, thermal black; graphene; carbon nanotubes; and mixtures thereof.

The active material may be present in the first layer or the second layer, in a content varying from 50 to 99% by mass relative to the total mass of ingredients of the first layer or the second layer

The organic binder(s) may be present in a content varying from 1 to 35% by mass relative to the total mass of ingredients in the first or the second layer.

Finally, the electron conducting carbon material may be present in a content varying from 1 to 20% by mass relative to the total mass of ingredients in the first layer or the second layer.

Each of these layers (namely the first layer and the second layer) can be between 10 μm and 200 μm thick and may also be between 0.001 m and 1 m wide and between 0.01 m and 100 m long.

According to the invention, each of the first layer and the second layer is partly coated with a strip assembly composed of a metal, the corresponding cations of which are those involved in the ion insertion and deinsertion process or the alloy formation and dealloying process in the active material of the first layer and the second layer, said strips being separated from each other along the electrode longitudinal direction and each extending in length along a strip longitudinal direction substantially perpendicular to said electrode longitudinal direction.

It is understood that the face of the first layer and the face of the second layer on each of which a strip assembly is deposited, does not correspond to the faces used as deposition faces on the current collector. In other words, each of the first layer and the second layer can be defined as a layer comprising an active material deposited, via a first face, on a face of a current collector and being coated on a second face by a strip assembly as defined above, each strip being composed of a metal, of which the corresponding cations are those involved in the ion insertion or deinsertion process or the alloy formation or dealloying process in the active material of the first layer and the second layer, said first face and said second face being opposite to each other.

The strips composed of a metal in the strip assembly coating the first layer and the strip assembly coating the second layer may in particular be:
strips composed of an alkali metal when the accumulator in which the negative electrode will be incorporated is an M¹-ion accumulator, in which M¹ represents an alkali ion (such as lithium ions when the accumulator is a lithium-ion accumulator in which case the strips are composed of metallic lithium; sodium ions when the accumulator is a sodium-ion accumulator in which case the strips are composed of metallic sodium; potassium ions when the accumulator is a potassium-ion accumulator in which case the strips are composed of metallic potassium); or
strips composed of an alkali earth metal when the accumulator in which the negative electrode will be incorporated is an M²-ion accumulator, in which M² represents an alkali earth ion (such as magnesium ions when the accumulator is a magnesium-ion accumulator in which case the strips are composed of metallic magnesium; calcium ions when the accumulator is a calcium-ion accumulator in which case the strips are composed of metallic calcium).

Each of these strips in the strip assembly coating the first layer and the strip assembly coating the second layer may be in the form of a metal strip with a thickness varying from 1 μm to 200 μm, for example a thickness greater than or equal to 50 μm, for example equal to 50 μm, and moreover may have a width identical to the width of the electrode and a length varying from 0.1 cm to 2 cm.

For each layer, the strip assembly is composed of n strips, where n is an integer equal to at least 3, and more specifically can vary from 3 to 100 (for example equal to 12).

In particular, the strip assembly in the first layer and the strip assembly in the second layer have the same number of bands. Even more specifically, the strips in the strip assembly in the first layer and the strips in the strip assembly in the second layer have the same dimensions (for example the same thickness, length and width).

The current collector located between the first layer and the second layer may be unperforated and more specifically can be in the form of metal foil.

The thickness of the current collector can vary from 5 μm to 100 μm, for example 10 μm, and moreover may have a length varying from 0.01 m to 100 m and a width varying from 0.001 m to 1 m and generally being in the shape of a strip.

Finally, from a composition point of view, the current collector may comprise (or even be composed of) one or several metals chosen from among copper, aluminium, titanium and alloys thereof.

According to one particular embodiment of the invention, each layer (namely the first layer and the second layer mentioned above) has a first end without any strips extending along the electrode longitudinal direction, said first end having a length z₁ (along the electrode longitudinal direction), this length z₁ preferably being identical for the first layer and for the second layer. Furthermore, the value of the length z₁ in particular is longer than the maximum separation y₁ along the electrode longitudinal direction for each pair of two directly consecutive strips in the strip assembly. In particular, the maximum separation y₁ is identical for each pair of two directly consecutive strips in the strip assembly in the first layer and this maximum separation y₁ is identical for each pair of two directly consecutive strips in the strip assembly in the second layer. Even more specifically, this maximum separation y₁ may be equal for the first layer and for the first layer.

Furthermore, each layer (namely the first layer and the second layer mentioned above) has a second end that has no strips extending along the electrode longitudinal direction and opposite to the first end. This second end may have a length x₁ (along the electrode longitudinal direction), which is less than the length z₁, this length x₁ preferably being identical for the first layer and for the second layer, and advantageously the length z₁ is preferably identical for the first layer and for the second layer.

This length z₁ may in particular satisfy the following relation:

z₁=L−x₁−y₁*(1−n)−l*n

in which:
L is the total length along the electrode longitudinal direction of the layer concerned (namely the first layer and/or the second layer);
x₁ is the length along the electrode longitudinal direction of the second end of the layer concerned (namely the first layer and/or the second layer);
y₁ is the separation along the electrode longitudinal direction, for each pair of two directly consecutive strips in the strip assembly in the layer concerned (namely the first layer and/or the second layer);
n is the number of strips in the strip assembly in the layer concerned;
l is the width (along the electrode longitudinal direction) of each strip in the strip assembly.

In particular:
for each strip assembly, y₁ can be identical for each pair of two directly consecutive strips in the strip assembly;
for the strip assembly in the first layer and the strip assembly in the second layer, y₁ can be identical for these two layers;
for each strip assembly, l can be identical;
for the strip assembly in the first layer and the strip assembly in the second layer, l can be identical for these each strip; and/or
L, x₁ and n can be identical for the first layer and the second layer.

The separation y₁ can satisfy the following relation:

y₁=2x₁

in which x₁ corresponds to the definition given above.

In particular, the separation along the electrode longitudinal direction, for each pair of two directly consecutive strips in the strip assembly in the layer concerned (said separation may correspond to that denoted y₁ in the above formulas), can be less than 2 cm and, more specifically, can advantageously vary from 0.1 cm to 2 cm, this range corresponding to an optimum longitudinal diffusion distance so that the corrosion phase takes place under good conditions.

According to one particular embodiment of the invention, the first end of the first layer is opposite the first end of the second layer along the electrode longitudinal direction, this situation being illustrated particularly on [FIG. 1], that will be commented upon in more detail below.

Finally, according to another particular embodiment of the invention, at least one strip in the strip assembly in the first layer is located along the electrode thickness direction, at least partly corresponding to a free zone defined between two directly consecutive strips coating the second layer, and vice versa.

In the above and in the following description, electrode thickness direction means the direction orthogonal to the electrode longitudinal direction and to the electrode width direction.

More specifically, each strip in at least part of the strip assembly in the first layer is located along the electrode thickness direction, at least partly corresponding to a free zone defined between two directly consecutive strips coating the second layer, and vice versa.

In other words, the strips in the first layer and the strips in the second layer are arranged such that when the electrode is viewed along the electrode width direction, at least some of the strips in the first layer and in the second layer are arranged in a staggered layout.

This situation is illustrated on [FIG. 1] attached in the appendix that is an exploded view representing the two opposite faces of a specific electrode conforming with the invention and more specifically, the following elements:
the first layer 1 having a total length L with a first end 3 with length z₁ and a second end 5 with length x₁ and being coated, between this first end and this second end, with a set of 12 strips (references 2, 4, 6, 8, 10, 12, 14, 16, 18, 20, 22 and 24 respectively) with identical widths l, each pair of directly consecutive strips having a spacing equal to the value y₁;
the second layer 7 opposite the first layer, said second layer having a total length L with a first end 9 with length z₁ and a second end 11 with length x₁ and being coated, between this first end and this second end, with a set of 12 strips (references 26, 28, 30, 32, 34, 36, 38, 40, 42, 44, 46 and 48 respectively) with identical widths l, each pair of directly consecutive strips having a spacing equal to the value y₁;
the strips references 12, 14, 16, 18, 20, 22 and 24 being located along the electrode thickness direction, at least partly corresponding to a free zone defined between two directly consecutive strips coating the second layer, namely:
for strip 12, the free zone defined between strips 26 and 28 in the second layer;
for strip 14, the free zone defined between strips 28 and 30 in the second layer;
for strip 16, the free zone defined between strips 30 and 32 in the second layer;
for strip 18, the free zone defined between strips 32 and 34 in the second layer;
for strip 20, the free zone defined between strips 34 and 36 in the second layer;
for strip 22, the free zone defined between strips 36 and 38 in the second layer; and
for strip 24, the free zone defined between strips 38 and 40 in the second layer.

Conversely, the strips references 26, 28, 30, 32, 34, 36 and 38 are located along the electrode thickness direction, at least partly corresponding to a free zone defined between two directly consecutive strips coating the first layer, namely:
for strip 26, the free zone defined between strips 10 and 12 in the first layer;
for strip 28, the free zone defined between strips 12 and 14 in the first layer;
for strip 30, the free zone defined between strips 14 and 16 in the first layer;
for strip 32, the free zone defined between strips 16 and 18 in the first layer;
for strip 34, the free zone defined between strips 18 and 20 in the first layer;
for strip 36, the free zone defined between strips 20 and 22 in the first layer; and
for strip 38, the free zone defined between strips 22 and 24 in the first layer.

The first layer 1 and the second layer 9 are deposited on each side of an unperforated collector 11.

This figure also represents a coordinate system illustrating the electrode longitudinal direction X, the electrode width direction Y and the electrode thickness direction Z.

The negative electrodes according to the invention can be prepared using a method including the following steps:

a) a step to deposit a first layer on a current collector, comprising an active material on a first face of the current collector and a second layer comprising an active material on a second face of the current collector, said first face and said second face being opposite each other;

b) a step to deposit a strip assembly each composed of a metal on each of the layers (namely the first layer and the second layer), the corresponding cations of the metal are those involved in the ion insertion and deinsertion process or the alloy formation or dealloying process in the active material of the first layer and the second layer, said strips being separated from each other along the electrode longitudinal direction and each extending in length along a strip longitudinal direction substantially perpendicular to said electrode longitudinal direction.

The deposition step a) thus comprises two phases: an operation to deposit the first layer on a first face of the current collector, the first layer comprising an active material and an operation to deposit the second layer on a second face of the current collector, the second layer comprising an active material, these two operations possibly being simultaneous.

More specifically, each deposition operation, either successive or simultaneous, may consist of depositing a liquid composition that can be qualified as an ink) comprising ingredients making up the layers concerned (in particular the active material, possibly an organic binder and possibly an electron conducting carbon material), the liquid composition advantageously being identical for the first layer and the second layer, when the first layer and the second layer are identical.

These deposition operations can be done using classical deposition techniques such as spraying, dip coating, coating, deposition by slot-die coating.

The layer thus deposited can be dried after each deposition operation.

The deposition step b) on each layer may consist of bringing the strip assembly mentioned above into contact and depending on the required layout satisfying the criteria according to the invention and co-rolling to assure good bond between the strip assembly and the layer concerned. To achieve this, the assembly formed by the first layer coated with a strip assembly, the second layer coated with a strip assembly and the current collector arranged between the first layer and the second layer is passed through a device comprising two rollers capable of achieving sufficient bond without adding too many constraints on the electrode.

The negative electrodes according to the invention can be inserted as is in an accumulator, and when the accumulator has a spiral architecture, they may be assembled using usual assembly techniques by spiral winding.

The invention also relates to a method for activation of a negative electrode as defined above comprising a step to bring the negative electrode into contact with an electrolyte for a fixed duration and at a fixed temperature to cause corrosion of the metal in the strip assemblies into metal cations (for example, Li⁺ cations when the strip assemblies are composed of lithium, Na⁺ cations when the strip assemblies are composed of sodium, K⁺ cations when the strip assemblies are composed of potassium).

More specifically, the step to bring the negative electrode into contact with an electrolyte may be done using the following operations:
an operation to place the negative electrode in an ion insertion and deinsertion or alloy formation and dealloying accumulator type device;
an operation to bring the accumulator into contact with an electrolyte for a fixed duration and at a fixed temperature to cause corrosion of the metal in the strip assemblies into metal cations (for example, Li⁺ cations when the strip assemblies are composed of lithium, Na⁺ cations when the strip assemblies are composed of sodium, K⁺ cations when the strip assemblies are composed of potassium).

The operation to make contact can be done by placing said accumulator in a bag comprising the electrolyte, this bag possibly being a hermetically sealed flexible or rigid bag (for example a heat sealed bag), and then placing the bag comprising the electrolyte into a drying oven for a fixed duration and at a fixed temperature (for example, 40° C. for 4 days). Concomitantly to this operation, it may be applied a pressure to generate a mechanical stress that will enable better diffusion of metallic ions originating from corrosion.

In particular, the electrolyte may be a liquid electrolyte comprising a metal salt dissolved in at least one organic solvent such as an apolar aprotic solvent, the metal salt more specifically comprising a metal cation with exactly the same nature as the metal cations originating from corrosion of the layer composed of a metal.

The metal salt may in particular be a lithium salt when the strips are composed of lithium.

As examples of lithium salts, mention may be made of LiClO₄, LiAsF₆, LiPF₆, LiBF₄, LiRfSO₃, LiCH₃SO₃, LiN(RfSO₂)₂, Rf being chosen from among F or a perfluoroalkyl group containing 1 to 8 carbon atoms, lithium trifluoromethanesulfonylimidide (known under the abbreviation LiTFSI), lithium bis(oxalato)borate (known under the abbreviation LiBOB), lithium bis(perfluorethylsulfonyl)imidide also known under the abbreviation LiBETI), lithium fluoroalkylphosphate (known under the abbreviation LiFAP).

As examples of organic solvents that can be used in the composition of the electrolyte, mention may be made of carbonate solvents, such as cyclic carbonate solvents, linear carbonate solvents and mixtures thereof.

As examples of cyclic carbonate solvents, mention may be made of ethylene carbonate (symbolised by the abbreviation EC), propylene carbonate (symbolised by the abbreviation PC).

As examples of linear carbonate solvents, mention may be made of diethyl carbonate (symbolised by the abbreviation DEC), dimethyl carbonate (symbolised by the abbreviation DMC), or ethylmethyl carbonate (symbolised by the abbreviation EMC).

At the end of the method described above, the strip assemblies have been corroded, and all or some of the metal has been transformed into metal ions that have combined with the active material and/or have contributed to the formation of a passivation layer on the surface of the electrode.

Finally, the invention relates to an accumulator operating on the ion insertion and deinsertion principle and/or the alloy formation and dealloying principle comprising a negative electrode as defined above or a negative electrode obtained following the activation method defined above.

More specifically, when the accumulator has a spiral configuration, comprising a positive electrode and a negative electrode as defined above, the positive electrode and the negative electrode being arranged on each side of an electrolytic separator, the assembly composed of the positive electrode, the electrolytic separator and the negative electrode being wound to form a spiral winding. More specifically, the negative electrode is wound around an axis parallel to the electrode width direction.

In the above and in the following description, positive electrode classically means the electrode that acts as the cathode when the generator outputs current (in other words when it is in the discharge process) and that acts as the anode when the generator is in the charge process.

The positive electrode classically comprises an active material in other words a material that can participate in insertion and deinsertion reactions that occur when the accumulator is functioning (when it is functioning according to the ion insertion and deinsertion principle) or in alloy formation and dealloying reactions (when the accumulator is an accumulator functioning according to the alloy formation and dealloying principle).

When the accumulator is an M¹-ion type accumulator (M¹ being an alkali ion such as Li, Na, K), the active material of the electrode can be a material of the M¹ oxide type comprising at least one metallic transition and/or post-transition element, of the M¹ phosphate type comprising at least one metallic transition element, of the M¹ silicate type comprising at least one metallic transition element or of the M¹ borate type comprising at least one metallic transition element.

Among examples of M¹ oxide compounds comprising at least one metallic transition and/or post-transition element, mention may be made of simple oxides or mixed oxides (in other words oxides containing several distinct metallic transition and/or post-transition elements) comprising at least one metallic transition and/or post-transition element, such as oxides containing nickel, cobalt, manganese and/or aluminium (these oxides possibly being mixed oxides).

More specifically, among mixed oxides containing nickel, cobalt, manganese and/or aluminium, mention can be made of the compounds with the following formula:

M¹M′O₂

wherein M′ is an element chosen from among Ni, Co, Mn, Al and mixtures thereof and M¹ is an alkali element.

Among examples of such oxides, mention may be made of lithiated oxides LiCoO₂, LiNiO₂ and mixed oxides Li(Ni,Co,Mn)O₂ (such as Li(Ni_{1/3}Mn_{1/3}Co_{1/3})O₂ or Li(Ni_{0.6}Mn_{0.2}Co_{0.2})O₂ (also known under the name NMC), Li(Ni,Co,Al)O₂ (such as Li(Ni_{0.8}Co_{0.15}Al_{0.05})O₂ also known under the name NCA) or Li(Ni,Co,Mn,Al)O₂, oxides said to be lithium-rich oxides Li₁₊ₓ(Ni,Co,Mn)O₂, in which x is greater than 0.

Among examples of such oxides, mention may be made of sodium oxides NaCoO₂, NaNiO₂ and mixed oxides Na(Ni,Co,Mn)O₂ (such as Na(Ni_{1/3}Mn_{1/3}Co_{1/3})O₂), Na(Ni,Co,Al)O₂ (such as Na(Ni_{0.8}Co_{0.15}Al_{0.05})O₂) or Na(Ni,Co,Mn,Al)O₂.

Among examples of M¹ phosphate compounds containing at least one metallic transition element, mention may be made of compounds with formula M¹M″PO₄, wherein M″ is chosen from among Fe, Mn, Ni, Co and mixtures thereof and M¹ is an alkali element, such as LiFePO₄.

Among examples of M¹ silicate compounds containing at least one metallic transition element, mention may be made of compounds with formula M¹₂M′″SiO₄, wherein M′″ is chosen from among Fe, Mn, Ni, Co and mixtures thereof and M¹ is an alkali element.

Among examples of lithiated borate compounds containing at least one metallic transition element, mention may be made of compounds with formula M¹M′″BO₃, wherein M′″ is chosen from among Fe, Mn, Co and mixtures thereof and M¹ is an alkali element.

When the accumulator is an M²-ion type accumulator (in which M² is an alkali earth ion), the active material of the electrode can be MoS₆.

Furthermore, the positive electrode may also include at least one organic binder such as a polymeric binder, such as polyvinylidene fluoride (PVDF), a mixture of carboxymethylcellulose with a styrene and/or acrylic latex and at least one electricity conducting additive, that can be a carbon material such as carbon black. Furthermore, the positive electrode can structurally be a composite material comprising a matrix of organic binder(s) within which fillers are dispersed composed of the active material (for example in particulate form) and possibly the electricity conductive additive(s).

The electrolytic separator is classically a porous polymeric membrane impregnated with an electrolyte, such as a liquid electrolyte as defined above.

The description of negative electrodes according to the invention has been made based on a plane configuration of the invention but these electrodes could be used wound around an axis parallel to the electrode width direction, which is the case for accumulators according to the invention adopting a wound or spiral architecture for which the negative electrodes according to the invention are particularly well suited.

Other characteristics and advantages of the invention will become clear after reading the following additional description and that applies to particular embodiments.

Obviously, this additional description is only given to illustrate the invention and in no way forms a limitation of it.

### BRIEF DESCRIPTION OF THE DRAWINGS

FIG. 1, already commented upon, illustrates a specific negative electrode conforming with the invention and shown in an exploded view.

FIG. 2 is a graph representing the variation of the discharged capacity C (in mAh) as a function of the number of cycles N.

### DETAILED PRESENTATION OF PARTICULAR EMBODIMENTS

### Example

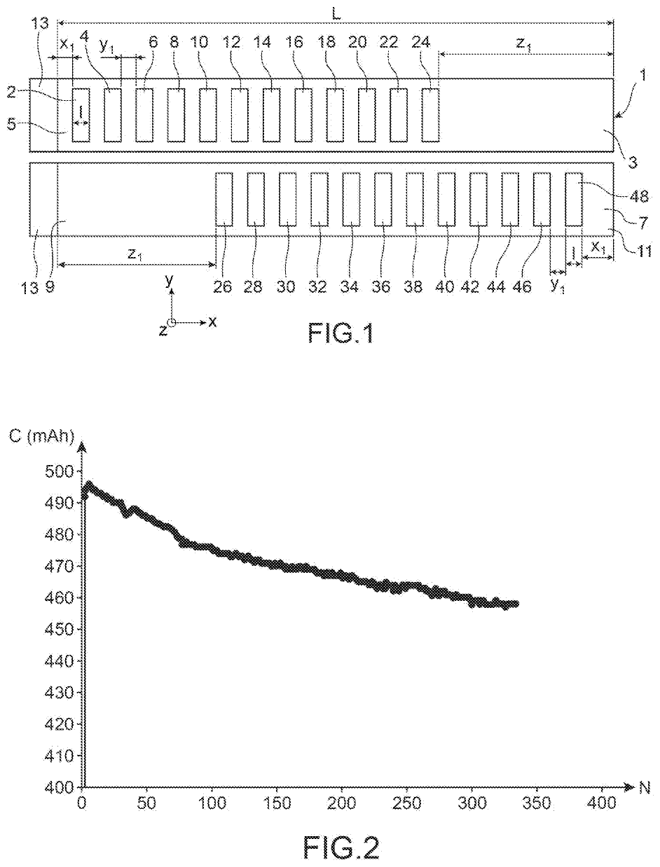

This example illustrates the preparation of an accumulator with a spiral architecture, in which the negative electrode corresponds that shown on [FIG. 1] attached in the appendix.

More specifically, the accumulator comprises:
a positive electrode composed of a composite material comprising 92% by mass of an NMC type active material, 4% by mass of a Super P65 (Imerys) type carbon black electron conducting additive and 4% by mass of a PVDF (Solvay) type binder, the positive electrode being 65 μm thick and being associated with an aluminium foil type current collector with a thickness of 20 μm, the capacity per unit area of the positive electrode being fixed at 2 mAh/cm²/face;
a 20 μm thick Celgard® 2320 type polymeric separator with a porosity of 40%;
for the negative electrode, the first layer and the second layer composed of a composite material comprising an active material consisting of a graphite silicon composite (92% by mass), 2% by mass of a Super P65 type carbon black electron conducting additive and 6% by mass of an acrylic polymer type binder, said electrode being associated with a 10 μm copper foil type current collector.

The capacity per unit area of the negative electrode is fixed at 6 mAh/cm²/face. It then remains to prelithiate 4 mAh/cm², and thus conserve 2 mAh/cm² cyclable with the capacity of the positive electrode.

The 65 μm thick positive electrode is 239 mm long over a width of 63 mm. The collector is exposed over a strip 6 mm wide at one of the ends of the strip so as to be able to solder an aluminium current transfer tab.

The 100 μm thick negative electrode is 310 mm long and 66 mm wide. The collector is exposed over a 6 mm strip at one of the ends of the strip so as to solder a nickel current transfer tab.

It is calculated that 24 50×10 mm (50 μm thick) lithium strips correspond to 120 cm², namely the 1200 mAh necessary to prelithiate 4 mAh/cm of negative electrode.

The 50 μm thick lithium strips are arranged on the negative electrode in the manner illustrated on [FIG. 1], with the following dimensions: x₁ corresponding to 5 mm and y₁ corresponding to 10 mm.

They are also distributed assuring that they are not arranged on at the beginning and the end of the electrodes that are inactive in the chosen prismatic spiral design (winding on a 34 mm wide flat mandrel), the length z₁ of 69 mm corresponding to the first and last turns on the spool, in which the negative electrode is not facing a positive electrode.

The accumulator is fabricated by simultaneously winding the 4 components (positive electrode/separator/negative electrode/separator) so as to form a prismatic coil with dimensions 40×70×5 mm.

The accumulator thus obtained is placed in an aluminised flexible bag (multilayer packaging comprising a polypropylene type hot melt polymer rolled on an aluminium foil acting as a vapour barrier and a third polyamide type polymer, the melting temperature of which is higher than the melting temperature of the internal layer) and then filled with electrolyte comprising LiPF₆ (1M) and a mixture of ethylmethyl carbonate (EMC) and fluoroethylene carbonate (in the proportion 70/30) and 2% by mass of vinylene carbonate (VC). The bag is then heat sealed at low pressure.

The accumulator is then placed in a drying oven for 4 days, at a temperature fixed at 40° C. under a mechanical stress applied by means of support plates placed so as to apply a pressure on each side of the accumulator contained in the bag, this treatment making it possible to obtain corrosion of the layer composed of lithium and diffusion of lithium ions through the entire thickness of the negative electrode.

After these 4 days, the accumulator conforming with the invention is subjected to a formation cycle at C/10 between 2.5 and 4.2V then a cycling test at C/20 for more than 200 cycles, the result of this test being shown on [FIG. 2] attached in the Appendix, this figure illustrates the variation in the discharged capacity C (in mAh) as a function of the number of cycles N.

The capacity obtained remains at a high level even after more than 200 cycles.

1. Negative electrode for an accumulator functioning based on the ion insertion and deinsertion principle and/or based on the alloy formation and dealloying principle comprising:
a first layer (1) comprising an active material deposited via one of its faces, on a first face of a current collector (13);
a second layer (7) comprising an active material deposited via one of its faces, on a second face of a current collector (13), said first face being opposite said second face;
said negative electrode extending in length along an electrode longitudinal direction,
wherein each of the first layer and the second layer is partly coated with an assembly of strips (2, 4, 6, 8, 10, 12, 14, 16, 18, 20, 22, 24, 26, 28, 30, 32, 34, 36, 38, 40, 42, 44, 46, 48) each composed of a metal, the corresponding cations of which are those involved in the ion insertion and deinsertion process and/or in the alloy formation and dealloying process in the active material of the first layer and the second layer, said strips being separated from each other along the electrode longitudinal direction and each extending in length along a strip longitudinal direction substantially perpendicular to said electrode longitudinal direction.

2. Negative electrode according to claim 1, wherein the active material, either for the first layer (1) and/or the second layer (7), is:
a material that can intercalate or deintercalate alkali ions; or
a material that can intercalate or deintercalate alkali earth ions.

3. Negative electrode according to claim 1, wherein the active material, either for the first layer (1) and/or the second layer (7), is chosen from among:
silicon;
a carbon material such as hard carbon, natural graphite or artificial graphite; and;
mixtures thereof.

4. Negative electrode according to claim 1, wherein the strips composed of a metal among the set of strips (2, 4, 6, 8, 10, 12, 14, 16, 18, 20, 22, 24) coating the first layer and the set of strips (26, 28, 30, 32, 34, 36, 38, 40, 42, 44, 46, 48) coating the second layer are strips composed of an alkali metal or strips composed of an alkali earth metal.

5. Negative electrode according to claim 1, wherein each strip in the set of strips (2, 4, 6, 8, 10, 12, 14, 16, 18, 20, 22, 24) coating the first layer and the set of strips (26, 28, 30, 32, 34, 36, 38, 40, 42, 44, 46, 48) coating the second layer are in the form of a metal strip with a thickness greater than or equal to 50 μm.

6. Negative electrode according to claim 1, wherein the current collector (13) is an unperforated collector in the form of metal foil.

7. Negative electrode according to claim 1, wherein the current collector (13) comprises one or several metals chosen from among copper, aluminium and alloys thereof.

8. Negative electrode according to claim 1, wherein each layer (namely the first layer and the second layer) has a first end (3, 9) without any strips extending along the electrode longitudinal direction, said first end (3, 9) having a length z₁ along the electrode longitudinal direction.

9. Negative electrode according to claim 8, wherein the value of the length z₁ along the electrode longitudinal direction is greater than the maximum separation y₁ for each pair of two directly consecutive strips in the strip assembly.

10. Negative electrode according to claim 1, wherein each layer (namely the first layer and the second layer) has a second end (5, 11) that has no strips extending along the electrode longitudinal direction and opposite to the first end.

11. Negative electrode according to claim 10, wherein the length x₁ of the second end (5, 11) along the electrode longitudinal direction is less than the length z₁.

12. Negative electrode according to claim 9, wherein the length z₁ satisfies the following relation:
z₁=L−x₁−y₁*(1−n)−l*n
in which:
L is the total length along the electrode longitudinal direction of the layer concerned (namely the first layer and/or the second layer);
x₁ is the length along the electrode longitudinal direction of the second end of the layer concerned (namely the first layer and/or the second layer);
y₁ is the separation along the electrode longitudinal direction, for each pair of two directly consecutive strips in the strip assembly in the layer concerned (namely the first layer and/or the second layer);
n is the number of strips in the strip assembly in the layer concerned;
l is the width (along the electrode longitudinal direction) of each strip in the set of strips.

13. Negative electrode according to claim 9, wherein the separation y₁ satisfies the following relation:
y₁=2x₁
in which x₁ is the length along the electrode longitudinal direction of the second end of the layer concerned (namely the first layer and/or the second layer).

14. Negative electrode according to claim 1, wherein the separation along the electrode longitudinal direction, for each pair of two directly consecutive strips in the strip assembly in the layer concerned is less than 2 cm.

15. Negative electrode according to claim 10, wherein the first end (3) of the first layer (1) is located opposite the first end (9) of the second layer (7) along the electrode longitudinal direction.

16. Negative electrode according to claim 1, wherein at least one strip in the strip assembly in the first layer is located along the electrode thickness direction, at least partly corresponding to a free zone defined between two directly consecutive strips coating the second layer, and vice versa.

17. Negative electrode according to claim 1, wherein each strip in at least part of the strip assembly in the first layer is located along the electrode thickness direction, at least partly corresponding to a free zone defined between two directly consecutive strips coating the second layer, and vice versa.

18. Method of preparing a negative electrode as defined in claim 1, comprising the following steps:
a) a step to deposit a first layer on a current collector, comprising an active material on a first face of the current collector and a second layer comprising an active material on a second face of the current collector, said first face and said second face being opposite each other;
b) a step to deposit a strip assembly each composed of a metal on each of the layers (namely the first layer and the second layer), the corresponding cations of the metal are those involved in the ion insertion and deinsertion process or the alloy formation or dealloying process in the active material of the first layer and the second layer, said strips being separated from each other along the electrode longitudinal direction and each extending in length along a strip longitudinal direction substantially perpendicular to said electrode longitudinal direction.

19. Method of activating a negative electrode as defined according to claim 1, comprising a step to bring the negative electrode into contact with an electrolyte for a fixed duration and at a fixed temperature to cause corrosion of the metal in the layer composed of a metal into metal cations.

20. Accumulator functioning based on the principle of ion insertion-deinsertion and/or the alloy formation and dealloying process comprising a negative electrode as defined according to claim 1.

21. Accumulator according to claim 20, that is a spiral architecture accumulator, wherein the negative electrode is wound around an axis parallel to the electrode width direction.

22. Accumulator functioning based on the principle of ion insertion-deinsertion and/or the alloy formation and dealloying process comprising a negative electrode obtained after the activation method defined in claim 19.

23. Accumulator according to claim 22, that is a spiral architecture accumulator, wherein the negative electrode is wound around an axis parallel to the electrode width direction.
